(19) United States
(12) Patent Application Publication
(10) Pub. No.: US 2025/0156773 A1
(43) Pub. Date: May 15, 2025

(54) Method and System for Variable Granularity Allocation of Parking Resources

(71) Applicant: VM Consolidated, Inc., Mesa, AZ (US)

(72) Inventors: David John Hart, Acton (CA); Kaleb S. Captain, Bloomington, IN (US); Aaron Grinnell, Carmel, IN (US); Joseph Houff, Minneapolis, MN (US)

(21) Appl. No.: 18/389,094

(22) Filed: Nov. 13, 2023

(51) Int. Cl. G06Q 10/02; G06Q 20/36; G06Q 30/0601

(52) U.S. Cl. CPC G06Q 10/02; G06Q 20/36; G06Q 30/0633

(57) ABSTRACT

A parking management system, method, and apparatus are provided with a processor, memory, and separate read and write databases connected to implement a CQRS database access pattern, where the processor executes instructions to communicate with a customer web application to receive a parking space search request which specifies a parking facility selected from a plurality of parking facilities, and a plurality of parking dates and times selected from a plurality of configurable time intervals using a customer-selected recurrence measure; to retrieve a list of parking spaces from the read database which are available at the plurality of parking dates and times; to communicate with the customer web application to display the list of parking spaces; to receive a parking space reservation request which selects a first parking space from the available parking spaces; and to submit a command service request to the write database to update a parking space allocation.

### BACKGROUND OF THE INVENTION

### Field of the Invention

The present disclosure is directed in general to the field of parking management systems. In one aspect, the present disclosure relates to an apparatus, system and method for managing parking space reservation, allocation and payment.

### Description of the Related Art

Existing parking management systems typically allow the reservation or allocation of parking rights for full days or for certain time periods and days of the week. For example, parking permits for a university facility or a group of facilities are typically granted or reserved for specified time blocks, such as weekdays during work hours (e.g., 8 am to 8 pm) for a defined period (e.g., a Fall semester). Facility occupancy during these time blocks would be controlled by the number of permits issued, but such a permit reservation policy does not provide a true picture the actual facility occupancy over the lifetime of the reserved permits because parking customers were forced to purchase parking for the entire time block of the permit, even though the parking customer would only be parking a vehicle for a fraction of the reserved time that was purchased. For example, university parking customers (e.g., workers, staff, and students) only need parking for specific days and times, and not every day for an entire month, semester, or year. However, these university parking customers do not have a platform to purchase flexible parking that meet their specific needs while parking operations do not have an easy or automated way to offer a parking solution tailored to the individual needs of the university parking customers.

Such limitations of conventional parking permit reservation systems prevent optimization of parking facility space allocation, thereby resulting in lost revenue to the parking system owner over the long term. As seen from the foregoing, the existing parking management solutions are difficult to implement at a practical level by virtue of the challenges with providing a flexible and efficient parking reservation and tracking system which meets the needs of parking customers while optimizing park asset revenue.

### BRIEF DESCRIPTION OF THE DRAWINGS

The present disclosure may be understood, and its numerous objects, features and advantages obtained, when the following detailed description of a preferred embodiment is considered in conjunction with the following drawings.

FIG. 1 depicts a system block diagram of a command and query responsibility segregation pattern framework system for efficiently allocating parking reservations over granular time intervals in accordance with selected embodiments of the present disclosure.

FIG. 2 depicts a simplified flow chart showing the logic for a parking management system which enables customers to purchase parking for specific days and times on a specified basis in accordance with selected embodiments of the present disclosure.

FIG. 3 depicts data processing system components of a parking management system in accordance with selected embodiments of the present disclosure.

FIG. 4 is a simplified block diagram of a computer data processing system which may be used by a parking management server operator and/or parking customer to provide, reserve, allocate, manage, and purchase parking resources with a customer-specified variable granularity in accordance with selected embodiments of the present disclosure.

### DETAILED DESCRIPTION

An apparatus, system, architecture, methodology, and program code are described for a parking management system which allocates parking resources with a variable granularity that is controlled by the parking management system operator and selected by customers. This generates more revenue and optimizes the parking systems assets by providing an easy-to-use online platform that allows customers to purchase parking that meets their specific parking needs. In selected embodiments, a back end parking management server system enables dynamic configuration of pricing, allotments, and schedules based on the actual usage of parking assets by parking customers. In addition, the front end parking reservation application provides a user-friendly interface which facilitates the parking reservation process and allows parking customers to purchase parking for specific days and times, either on a one-time or recurring basis.

For both the back end parking management server system and the front end parking reservation application, the operator can assign, and the parking customer can select different configurable pricing levels at specified pricing intervals (e.g., 15 min, 30 min, 1 hour, 2 hours, 3 hours, 4 hours, 6 hours, 8 hours, 12 hours, or 1 day). As a result, the disclosed real time online parking management system enables parking customers to quickly purchase only the parking rights that they require, while also allowing parking facility operators to customize the parking experience based on historical parking trends or actual, real time occupancy or usage of the parking facility. In addition, the disclosed real time online parking management system can be integrated with one or more enforcement systems to provide the operator with additional revenue from enforcement and to discourage illegal parking.

As noted above, existing parking management systems typically provide a “one size fits all” solution for reserving parking spots, and do not provide a mechanism for purchasing parking at specific time intervals on specific dates and times or multiple dates and times on a recurring basis to meet the parking customer's specific needs. Nor do existing parking management systems provide a mechanism for parking system operators to optimize revenue by configuring pricing, allotments, and schedules based on real-time occupancy and future occupancy levels. To address these deficiencies and others known to those skilled in the art from existing parking management systems, the disclosed real time online parking management system allows eligible parking customers to specify space allocations and pricing based on verified group assignments or guest parking. As will be appreciated, parking allocations and pricing may be offered or excluded based on verified group assignment. In addition, parking customers can purchase parking reservations for the current period or in a future time interval based on the parking customer's specific parking needs. As a result, the operator of the disclosed real time online parking management system can then view real-time occupancy and future occupancy levels to dynamically adjust space allocations and pricing.

To this end, a “search and reserve” framework of the disclosed real time online parking management system enables parking customers to quickly search for available recurrent and non-recurring parking over time intervals, and to reserve the time intervals under load with a reservation mechanism that adjusts the available space allocations as each time interval is reserved or purchased.

While the “search and reserve” framework may be implemented with a single relational database that would handle all read and write operations, there are technical challenges with using the same database for both reading and writing operations with a parking transaction data table since contention conflicts to the shared data table can slow down search operations when parking customers are requesting available parking opinions. To solve this issue, a pair of separate databases are used for separately serving read and write operations, including a read database and a write database that are, respectively, which are optimized for read and write operations using separate read and write microservices. In particular, a command database is the database of record that is optimized for write modifications, and once a write operation is processed, the command database generates an event that is consumed a query database which is optimized for read operations.

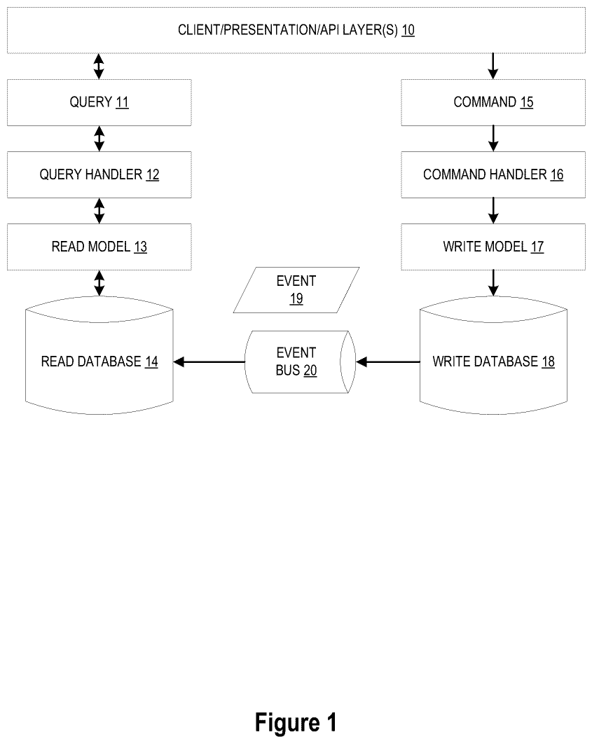

To provide additional details for an improved understanding of selected embodiments of the present disclosure, reference is now made to FIG. 1 which depicts a system block diagram of a command and query responsibility segregation (CQRS) pattern framework system 1 for efficiently allocating parking reservations over granular time intervals. As understood by those skilled in the art, CQRS is an architectural pattern wherein read and write operations typically use different data models that may be stored in different databases. This kind of segregation makes it easier to scale read and write operations by splitting data access into two microservices which use different databases which are optimized for read or write operations. In particular, a write microservice processes Commands for write data operations (such as create, update, delete) to a Write Database 18 which is the database of record and is optimized for write modifications. Once a write operation is processed by the Write Database 18, it generates an event 19 that is consumed by Read Database 14 which is optimized for read operations performed by a read microservice.

As depicted, the CQRS pattern framework system 1 may include a client/presentation interface layer 10 which represents the front-end of the application where users interact with the system. As disclosed herein, the parking customer may use the client/presentation interface layer 10 to access a web browser application (or other suitable application) to search, reserve and purchase for parking spaces which meet customer-specified date, time interval and recurrence search terms. In addition, the operator of a parking management system may use the client/presentation interface layer 10 to access a web browser application to track parking space occupancy, configure time intervals that are provided to parking customers, and otherwise customize the pricing schedules and availability for customer search and selection.

In operation, the client/presentation interface layer 10 may include a read or query API which sends queries to the Query class 11. In addition, the client/presentation interface layer 10 may include a write or command API which sends commands to the Command class 15. As understood by those skilled in the art, the client/presentation layer 10 resides at Layer 6 of the Open Systems Interconnection (OSI) communications model and ensures that communications that pass through it are in the appropriate form for the recipient application. In other words, the client/presentation layer 10 presents the data in a readable format from an application layer perspective.

On the write side of operations, the Command class 15 receives commands from the client/presentation interface layer 10 and dispatches them to the appropriate Command Handler 16. While the commands may be dispatched to the Command Handler 16 using a synchronous in-process Mediator, asynchronous methods, such as a Message Bus, may also be used in other embodiments. The Command Handler 16 is responsible for handling specific commands, including updating the Write Model 17 which represents the current state of the system. The Command Handler 16 also raises events which can be used to rebuild the Read Model 13. The Write Database 18 stores the Write Model 17. In addition, changes to the Write Database 17 are propagated to the Read Database 14 using asynchronous messaging/events 19 which are sent over the Event Bus 20. For example, an Apache Kafka event bus is designed for handling event communications at a large scale.

On the read side of operations, the Query class 11 receives queries from the client/presentation interface layer 10 and dispatches them to the appropriate Query Handler 12. For example, queries may be dispatched to the Query Handler 12 using a synchronous in-process Mediator. The Query Handler 12 is responsible for handling specific queries by retrieving data from the Read Model 13 and returning the read data to the client/presentation interface layer 10. The Read Database 14 stores the Read Model 13 which represents an optimized version of the Write Model 17 for specific read operations. The Read Model 13 can be rebuilt from the events.

As described more fully hereinbelow, the disclosed real time online parking management system uses the CQRS pattern framework system 1 to perform quick searches for available recurring and non-recurring parking over defined time intervals, while also reserving customer-selected time intervals under load with a design mechanism that adjusts the available parking space allocations as each time interval is reserved or purchased. As a result, the disclosed real time online parking management system provides parking customers with a mechanism for purchasing parking at specific time intervals on specific dates and times or multiple dates and times on a recurring basis. In particular, the parking management system is designed to allow eligible customers to select or choose specific space allocations and pricing based on verified group assignments or guest parking. Parking can be purchased for the current period or in the future depending on the customer's specific needs. The operator can then view real-time occupancy and future occupancy levels to dynamically adjust space allocations and pricing. The parking management system can also be integrated with multiple enforcement systems to provide the operator with additional revenue from enforcement and discourage illegal parking.

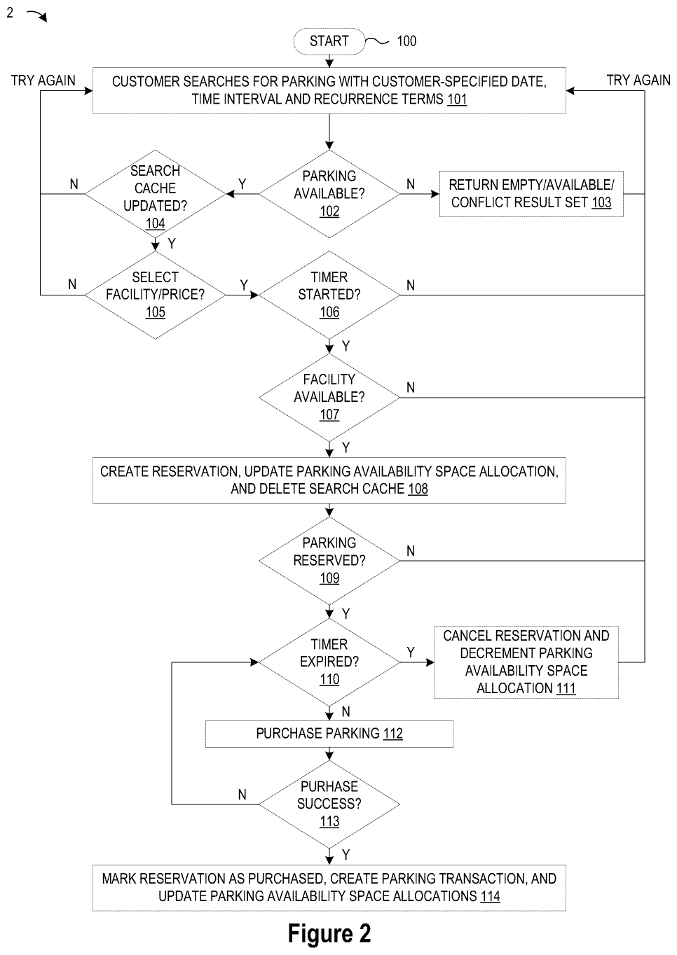

To provide additional details for an improved understanding of selected embodiments of the present disclosure, reference is now made to FIG. 2 which depicts a simplified flow chart 2 showing the logic for a real time online parking management system which enables customers to search, reserve, and purchase parking resources with a variable granularity that the customer specifies for desired parking days, times, and recurrence. As disclosed herein, the disclosed real time online parking management system and method for allocating parking resources may be implemented entirely in selected hardware, entirely in software (including firmware, resident software, micro-code, etc.) or in embodiments combining software and hardware aspects that may all generally be referred to herein as a “circuit,” “module” or “system.” Certain implementations may incorporate all, fewer, or greater than the components described herein.

In selected embodiments, the method for dynamically allocating parking resources on a customer-specified granular basis may include steps 100-114 shown in the general order of FIG. 2, though the method may include more or fewer steps or can arrange the order of the steps differently than those shown. Generally, the method starts with a start operation 100 and ends with purchase step 114 after processing steps 101-113 which are executed as a set of computer-executable instructions by one or more computer systems or processors and encoded or stored on a computer readable medium. In other configurations, the method may be executed by a series of components, circuits, and gates created in a hardware device, such as a System of Chip (SOC), Application Specific Integrated Circuit (ASIC), or a Field Programmable Gate Array (FPGA). In other configurations, the method may be executed as an iterative loop where the processing steps 100-114 are periodically repeated on a predetermined schedule or on certain triggering events or when prompted by a vehicle driver.

At step 100, the method starts, such as when the parking customer accesses a web browser which may be installed on the customer's computer system, mobile device, or a vehicle computer system.

At step 101, the parking customer searches one or more parking systems for available parking spaces using customer-specified date, time interval, and recurrence search terms. In selected embodiments, the customer search is done on a web-based search application having a user interface screen which displays one or more available parking systems, along with options for configuring or selecting pricing schedule dates, time intervals for a desired parking reservation. In addition, the user interface screen may display customer-selectable options for making the parking reservation a one-time reservation (e.g., for a specified place, date and time interval) or a recurring reservation of the parking place/date/time on a recurring basis (e.g., over specified days or weeks or months into the future). In support of such customer services, the parking management system operator may configure the system with configurable pricing schedule time intervals (e.g., 15 min, 30 min, 1 hour, 2 hours, 3 hours, 4 hours, 6 hours, 8 hours 12 hours or 1 day) that can be selected by the customer through the user interface screen. The parking management system operator may also configure the system user interface screen to provide parking space allocations and pricing terms that are assigned to parking customers based on a group assignment or verification process. Guest parking allocations may also be configured search options by parking management system operator. When a parking customer first searches for available parking, the parking management system returns the lowest priced time intervals for all valid facilities requested by the customer for display on the customer's user interface screen.

After the parking customer searches for parking spaces, the parking management system provides a sequence set of steps for reserving parking spaces before the customer purchases the parking reservation. To improve search efficiency with reduced latency and complexity, the search-reserve-purchase sequence may be implemented with CQRS pattern framework system using the separately defined write and read databases that are respectively optimized for command and query operations, as described above with regard to FIG. 1.

After the initial customer search step 101, the method checks at step 102 if the parking space is available at the customer-requested location, date, time and recurrence terms specified at step 101. If there are no parking spaces available that meet the customer-requested location, date, time and recurrence terms (negative outcome to detection step 102), then the backend server associated with the parking management system returns a result set or report at step 103. The results returned at step 103 can indicate that there are no parking spaces available which meet all of the requirements of the customer-requested location, date, time and recurrence terms. Alternatively, the results returned at step 103 can indicate where there are availability conflicts with the customer-requested location, date, time and recurrence terms (e.g., where there are existing schedule conflicts with the parking space) or which of the customer-requested location, date, time and recurrence terms are available for the requested parking space. However, if there are parking spaces available that meet the customer-requested location, date, time and recurrence terms (affirmative outcome to detection step 102), then the search process proceeds to the next step.

At step 104, a search cache memory is updated with search terms and available facilities that meet the customer-requested location, date, time and recurrence terms. Due to the expense and resources required to search the available parking spaces for spots that meet the customer-requested location, date, time and recurrence terms, the search cache memory provides a mechanism for retaining the search results (e.g., search terms, corresponding available matching time intervals for the requested parking space, and conflicts between search and available parking resources) without having to repeatedly perform the expensive search of available parking spaces. If there is any reason (e.g., exception or fault or other technical error in the system) that the search cache is not able to be updated (negative outcome to detection step 104), then the search process stops, and the backend server at the parking management system returns back to try another search at step 101. However, if the search cache is updated (affirmative outcome to detection step 104), then the search process proceeds to the next step.

At step 105, the customer is given the opportunity to select a parking facility having a parking spot that meets the customer-requested location, date, time and recurrence terms. If the parking management system determines that the customer has not selected an available parking facility and price (negative outcome to detection step 105), then the search process stops, and the backend server at the parking management system returns back to try another search at step 101. However, if the customer selects their desired parking facility and pricing (affirmative outcome to detection step 105), then the original cached search results are validated and then transformed into an active reservation using the next reservation processing steps. When the customer selects the parking facility and price, the parking management system decrements or removes the associated time interval from the customer-selected parking space availability in a transactional manner so that other parking customers do not seek to reserve the same parking space for that time.

After a successful search, a sequence of reservation processing steps begins at step 106 by starting a cart timer after the customer selects their desired facility and pricing reservation. As disclosed herein, the cart time may be configured with a time period that is suitable for the parking customer to perform the reservation and purchase processing steps described hereinbelow. If there is any reason that the cart timer cannot start (negative outcome to detection step 106), then the purchase process stops, and the backend server at the parking management system returns back to try another search at step 101. However, if the cart timer is started (affirmative outcome to detection step 106), then the reservation processing proceeds to the next step.

At step 107, the parking management system determines if the customer-requested parking facility is still available. In selected embodiments, the parking facility check step may be performed by checking to see if the available facilities listed in the search cache memory are still available. If any of the customer-requested time intervals for a parking facility and space are no longer available when the search cache is transformed to a reservation (negative outcome to detection step 107), then the parking customer will be unable to continue with the purchase and the backend server at the parking management system returns back to try another search at step 101. However, if the customer-requested time intervals for a parking facility and space are available (affirmative outcome to detection step 107), then the reservation processing proceeds to the next step.

As will be understood by those skilled in the art, there can be latency impacts from delays that occur during the customer search and selection steps 101-105, during which time other parking customers can submit conflicting parking search requests for the same parking space/date/times. These latency impacts can occur, even with CQRS framework systems which use a single database to handle both write and read commands. As the latency between the services increases, so does the possibility that a parking customer search could be retrieve facility time intervals that have already been purchased or reserved by another parking customer. This becomes more impactful when service load is high and available space allocations over certain time intervals get closer to zero. To minimize these latency impacts, the disclosed parking management system implements the CQRS framework system with separate read and write databases and an event bus for single directional communication between the write and read databases.

At step 108, the parking management system creates a reservation for the customer-requested parking space, date, and time. In addition, the available time intervals in the parking availability space allocation is updated to reflect that the customer-requested parking space is no longer available for allocation at the associated date and time. Finally, the parking management system deletes the corresponding search terms and results from the search memory cache.

At step 109, the parking management system confirms that the customer-requested parking space reservation was made. In effect, step 109 provides a reservation check, but this step can be omitted. If the customer-requested parking reservation is not made (negative outcome to detection step 109), then the backend server at the parking management system returns back to try another search at step 101. However, if the customer-requested parking reservation was successfully made (affirmative outcome to detection step 109), then a sequence of purchase processing steps begins.

The purchase processing steps begin at step 110 by checking to see if the cart timer has expired. If so (affirmative outcome to detection step 110), then the purchase process stops, and the backend server at the parking management system cancels the reservation and all reserved parking spaces, dates and time intervals are released for potential allocation to other customers at step 111 before returning back to try another search at step 101. In selected embodiments, the release of the reserved parking may include decrementing the parking availability space allocation that was previously made at step 108 for the parking customer reservation. However, if the cart timer is not expired (negative outcome to detection step 110), then the reservation processing proceeds to the next step.

At step 112, the parking customer purchases the reserved parking space which meets the customer-requested parking space, date, and time terms. While any suitable payment mechanism may be used for the parking purchase step 112, the parking customer may use any suitable digital wallet (e.g., Google Pay or Apple Pay or an OEM associated payments system) for automated payment of parking charges.

At step 113, the parking management system determines whether the parking purchase was successfully completed. If not (negative outcome to detection step 113), then the purchase process check back to see if the cart timer has expired (step 110) and the purchase process continues. However, if parking purchase was successfully completed (affirmative outcome to detection step 113), then the purchase processing proceeds to the next step.

Throughout the purchase process steps, the cart timer value may be shown to the parking customer on the client application user interface screen, but is also tracked on the service level to ensure any unpurchased reserved parking will be returned to the available inventory after a configurable time period has elapsed. This process will occur whether the parking customer is still actively using the client application or not. A parking customer can finalize the reservation by completing a purchase before the cart timer expires. Since the space allocations for the reserved time intervals have already been validated the final transaction process is simplified. It requires only the transaction to be recorded and the reservation counts to be decremented and the purchased counts to be incremented for each associated time interval.

At step 114, the parking management system marks the customer-requested parking reservation as purchased, creates a parking transaction, and updates the parking availability space allocations to reflect the fact that the customer-requested parking space is no longer available for allocation at the associated date and time. At this point, the parking transaction has been completed, and the parking customer is able to park in the appropriate facility at the reserved date, time, and location.

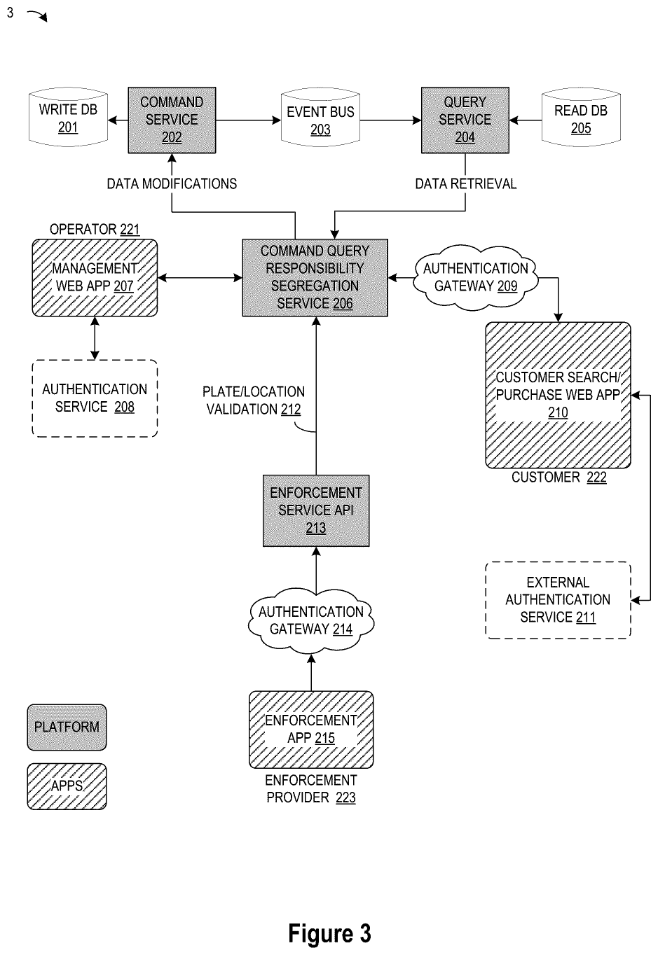

To provide additional details for an improved understanding of selected embodiments of the present disclosure, reference is now made to FIG. 3 depicts data processing system components 3 of a parking management system which enables customer reservation and purchase of parking at specific dates and time intervals on a one-time or recurring basis and which enables facility operators to optimize space allocation and pricing based on real time occupancy data. As disclosed herein, the parking management system and method may be implemented entirely in selected hardware, entirely in software (including firmware, resident software, micro-code, etc.) or in embodiments combining software and hardware aspects that may all generally be referred to herein as a “circuit,” “module” or “system.” Certain implementations may incorporate all, fewer, or greater than the components described herein.

The depicted data processing system provide a command service 202 and query service 204 which are connected and configured to implement a Command and Query Responsibility Segregation (CQRS) architecture by using a command query responsibility segregation service 206 to processes database interactions from the parking management system operator 221 and the parking customer 222. In particular, the CQRS service 206 transforms incoming database interactions from the operator 221 and customer 222 into separate pathways such that the command service 202 handles data modification (or write) requests with the write database 201, while the query service 204 separately handles data retrieval (or read) requests with the read database 205. With separate write and read databases 201, 205, write commands and read queries may be handled with separate, dedicated engines (or models such as Read Model 13 and Write Model 17) so that each model can act independently except as coupled through data ordering updates over the event bus 203 sent by the command service 202 to the query service 204. The segregation of pathways fits well with event-based programming in general, and each pathway may be implemented as a separate service 202, 204 that is connected to a respective database 201, 205 that is optimized, respectively, for write or read operations. For example, the write database 201 may be implemented with a MySQL relational database management system, while the read database 205 may be implemented with a data schema that is optimized for queries.

In support of securing customer access to the parking management system, an Authentication API Gateway 209 is provided which separates and protects the Command Service 202 and Query Service 204 from direct internet access by the customer. In addition, a customer search/purchase web application 210 is provided which enables a parking customer 222 to submit parking space search and reservation requests. As will be appreciated, the customer search/purchase web application 210 may be running on any suitable computer device, such as a laptop, desktop, mobile, or vehicle computer device. In order for the customer 222 to securely log into the customer search/purchase web application 210, an external authentication service 211 may be used as known to those skilled in the art. When processing a search request from the customer search/purchase web application 210, the Query Service 204 assembles a list of valid facility pricing schedules based on the search and group assignment for the customer 222 and the available parking space allocations for each time interval in the search parameters. Time intervals which have no remaining parking space allocations are returned so that the customer 222 can adjust the search. All facilities that have available parking with the associated cost are also returned in the results.

As disclosed herein, the customer search/purchase web application 210 may be configured to display a user interface screen which presents the customer 222 with search options to identify parking resources with a variable granularity of date, time, and recurrence requirements that may be configured and controlled by the parking management system operator 221 so that the customer 222 can specify, reserve, and purchase parking spaces that meets the specific parking needs of the customer 222. For example, the customer search/purchase web application 210 may disclose an initial search screen which lists one or more parking facilities that are available for searching on a selected date. After the customer 222 selects one or more parking facilities and an “all day” option for a selected date, the customer 222 may select an “add parking” button to update the search cache memory and to prompt the customer search/purchase web application 210 to reserve the customer-selected parking space and display a parking purchase payment page. Alternatively, if the customer 222 selects one or more parking facilities and an “recurrence” option from the initial search screen, the customer 222 may select a start date, a start time and end time using the defined timer intervals, a customer-selected recurrence period (e.g., weekly, monthly, yearly, etc.), and an end date, and then select a “search” button to update the search cache memory and prompt the customer search/purchase web application 210 to list one or more parking facilities that are available for the customer-selected date, time, and recurrence requirements. After the customer 222 selects one of the parking facilities clicks on an “add parking” button, the search cache memory is updated and the customer search/purchase web application 210 reserves the customer-selected parking space and displays a parking purchase payment page. As a result, the customer search/purchase web application 210 enables parking customers to quickly purchase only the parking rights that they require.

To manage the parking system resources, an operator 221 uses a management web application 207 which may be running on any suitable computer device, such as a laptop, desktop, mobile, backend server, or other computer device. In order for the operator 221 to securely log into the management web application 207, an authentication service 208 may be used as known to those skilled in the art. As disclosed herein, the management web application 207 may be configured to allow the parking management system operator 221 to customize the parking experience based on historical parking trends and/or actual, real time occupancy or usage of the parking facility. Such configuration options may include specifying pricing schedule time intervals (e.g., 15 min, 30 min, etc.) and recurrence options (e.g., specific days of the week, month or year), that can be selected by the customer 222. Configuration options may also include providing parking space allocations and pricing terms to parking customers based on a group assignment or verification process and/or based on a guest parking (unregistered) status of the customer 222. When a parking customer first searches for available parking, the parking management system returns the lowest priced time intervals for all valid facilities requested by the customer for display on the customer's user interface screen. In addition, the management web application 207 may be configured to identify the lowest price for a parking customer based on their group assignment, and then list the lowest price on the search results displayed to the customer 222 by the customer search/purchase web application 210. This feature may be applied when multiple pricing schedules are assigned to a single parking customer so that special pricing schedules can overwrite normal pricing schedules.

The disclosed management web application 207 also enables the operator 221 to use pricing schedules to assign costs to the time intervals (which can be as small as 15 minutes or as large as 24 hours) and parking schedule (which can include a week of time intervals). Once pricing schedules are assigned to one or more groups, the operator 221 may use the management web application 207 to assign facilities to a pricing schedule and assign space allocations to each time interval in the schedule. This allows for pricing and occupancy to assigned to a facility. Once assigned to a facility, each day of pricing in the schedule is transposed to the corresponding day that the pricing schedule is assigned to a facility. Special pricing schedules can override pricing on days with events, such as football games or ceremonies.

In addition, the parking management system can be integrated with one or more enforcement systems to provide the operator 221 with additional revenue from enforcement and to discourage illegal parking. To this end, the CQRS service 206 may be connected to an enforcement service API 213 which may be running on any suitable computer device, such as a laptop, desktop, mobile, backend server, or other computer device. In order for an enforcement application 215 to securely access the enforcement service API 213, an authentication service 214 is provided which separates and protects the enforcement API 215 for access by an enforcement provider 223. Requests from the enforcement service API 213 may include license plate information and a parking location validation request 212 that are converted by the CQRS Service 206 to a format that the Query Service 204 can consume. Similarly, the CQRS Service 206 transforms any response from the Query Service 204 to the expected response required by the enforcement provider. This approach allows for multiple enforcement provider implementations to be supported without modifying the Query Service 204.

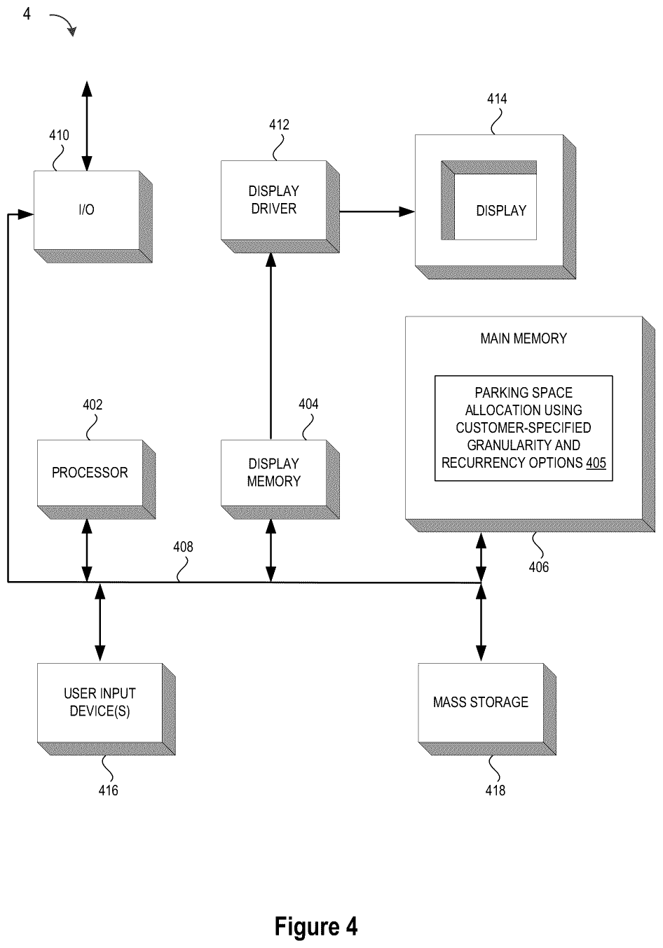

To provide additional details for an improved understanding of selected embodiments of the present disclosure, reference is now made to FIG. 4 which depicts a simplified block diagram of a computer data processing system 4 which may be used by a parking management server operator and/or parking customer to provide, reserve, allocate, manage, and purchase parking resources with a customer-specified variable granularity. As disclosed, the computer data processing system 4 includes input user device(s) 416, such as a keyboard and/or mouse, which are coupled to a bi-directional system bus 408. The input user device(s) 416 are used for introducing user input to the computer system 4 and communicating that user input to processor 402. The computer system 4 may also include a display memory 404, main memory 406, and mass storage 418, all coupled to bi-directional system bus 408 along with input user device(s) 416 and processor 402. The mass storage 418 may include both fixed and removable media, such as other available mass storage technology. Bus 408 may contain, for example, 32 address lines for addressing display memory 404 or main memory 406. The system bus 408 may also include, for example, an n-bit data bus for transferring data between and among the components, such as CPU 402, main memory 406, display memory 414, and mass storage 418, where “n” is, for example, 32 or 74. Alternatively, multiplex data/address lines may be used instead of separate data and address lines.

The computer system 4 may also include I/O device(s) 410 which provide connections to peripheral devices, such as a printer, and may also provide a direct connection to remote server computer systems via a telephone link or to the Internet via an ISP. I/O device(s) 410 may also include a network interface device to provide a direct connection to remote server computer systems via a direct network link to the Internet via a POP (point of presence). Such connection may be made using, for example, wireless techniques, including digital cellular telephone connection, Cellular Digital Packet Data (CDPD) connection, digital satellite data connection or the like. Examples of I/O devices include modems, sound and video devices, and specialized communication devices such as the aforementioned network interface.

Computer programs and data are generally stored as instructions and data in mass storage 418 until loaded into main memory 406 for execution. Computer programs may also be in the form of electronic signals modulated in accordance with the computer program and data communication technology when transferred via a network. The method and functions relating to system and method for providing, reserving, allocating, managing, and purchasing parking resources with a customer-specified variable granularity may be implemented in a parking space allocation computer program 405 which uses a CQRS pattern framework system with separate, dedicated read and write databases to allocate parking spaces using customer-specified granularity and recurrent options.

The processor 402, in one embodiment, is a microprocessor manufactured by Motorola Inc., Intel Corporation, Advanced Micro Devices, or any microprocessor manufacturer. However, any other suitable single or multiple microprocessors or microcomputers may be utilized. Main memory 406 is comprised of dynamic random access memory (DRAM). Display memory 404 is a dual-ported random access memory. One port of the memory 404 is coupled to display amplifier or driver 412. The display amplifier/drive 412 is used to drive the display 414. Display amplifier/drive 412 is well known in the art and may be implemented by any suitable means. This circuitry converts pixel data stored in display memory 404 to a raster signal suitable for use by display 414. Display 414 is a type of monitor suitable for displaying graphic images.

The data processing system components 402, 404, 406, 408, 410, 412, 414, 416, 418 depicted in the computer data processing system 4 are not intended to be exhaustive, but rather are representative to highlight components that can be implemented by the present disclosure. For instance, the data processing system components may include alternate memory storage devices. In addition, multiple processor devices may be used to run the parking space allocation computer program 405 at either or both of the customer or operator computer systems. These and other variations are intended to be within the spirit, scope and intent of the present disclosure.

By now it should be appreciated that there has been provided a parking management system, apparatus, method, and program code for dynamically managing parking spots in one or more parking facilities. The disclosed system includes a processor, a memory coupled to the processor, and a read database and a write database connected and configured to implement a command query responsibility segregation (CQRS) database access pattern. In the memory, computer executable instructions are stored and executed by the processor to communicate with a parking customer web application to receive a parking space search request which specifies a plurality of parking dates and times selected from a plurality of configurable time intervals using a customer-selected recurrence measure. In selected embodiments, the customer-selected recurrence measure specifies that the times selected from the plurality of configurable time intervals may recur on selected days, weeks, or months between a customer-selected start date and end date. In other embodiments, the customer-selected recurrence measure specifies that the times selected from the plurality of configurable time intervals may recur on customer-selected subset of up to four days in a week for a customer-selected time interval on each customer-selected subset of up to four days. In addition, the executed instructions cause the processor to submit a query service request to the read database using the CQRS database access pattern to retrieve a list of one or more parking spaces which are available at the plurality of parking dates and times. The executed instructions also cause the processor to communicate with the parking customer web application to display the list of one or more parking spaces which are available at the plurality of parking dates and times. In selected embodiments, the displayed list of one or more parking spaces includes price schedule information for the customer. In such embodiments, the price schedule information may assign different prices for different configurable time intervals. In addition, the executed instructions cause the processor to communicate with the parking customer web application to receive a parking space reservation request which selects a first parking space from the one or more parking spaces which are available at the plurality of parking dates and times. The executed instructions also cause the processor to submit a command service request to the write database using the CQRS database access pattern to update a parking space allocation to reflect that the first parking space has been allocated at the plurality of parking dates and times selected from the plurality of configurable time intervals using the customer-selected recurrence measure. In selected embodiments, the executed instructions also cause the processor to communicate with the parking customer web application to receive payment information for the first parking space, with payment being accepted after the customer reserves the first parking space. In selected embodiments, the parking management system also includes a search cache memory for storing the parking space search request and the corresponding list of one or more parking spaces which are available at the plurality of parking dates and times. In selected embodiments, the parking management system also includes a cart timer for setting a configurable time period for the customer to reserve and purchase the first parking space. In other embodiments, the executed instructions also cause the processor to communicate with a management web application on a parking management backend server to receive operator-configured plurality of configurable time intervals and price schedule information, and to communicate with the parking customer web application to display the operator-configured plurality of configurable time intervals and price schedule information with the list of one or more parking spaces which are available at the plurality of parking dates and times. In other embodiments, the parking management system also includes an enforcement service API gateway configured (1) to transform a request received from an external enforcement provider into a format that a query service can submit to the read database, and (2) to transform a response from the query service into a response format required by the external enforcement provider.

In another form, there is provided a computer-based method for managing a plurality of parking spaces at one or more parking facilities. In the disclose method, a parking management platform receives a parking space search request which specifies a plurality of parking dates and times selected by the customer from a plurality of configurable time intervals using a customer-selected recurrence measure, where the times selected from the plurality of configurable time intervals are less than a full day. In selected embodiments, the customer-selected recurrence measure specifies that the times selected from the plurality of configurable time intervals may recur on selected days, weeks, or months between a customer-selected start date and end date. In other selected embodiments, the customer-selected recurrence measure specifies that the times selected from the plurality of configurable time intervals may recur on customer-selected subset of up to four days in a week for a customer-selected time interval on each customer-selected subset of up to four days. In addition, the parking management platform submits a query service request through a query service at the parking management platform to a read database using a command query responsibility segregation (CQRS) database access pattern to retrieve a list of one or more parking spaces which are available at the plurality of parking dates and times. In selected embodiments, the list of one or more parking spaces includes price schedule information assigned to different configurable time intervals selected by the customer. The parking management platform also communicates with a parking customer web application to display the list of one or more parking spaces which are available at the plurality of parking dates and times. In addition, the parking management platform receives from the parking customer web application a parking space reservation request which selects a first parking space from the one or more parking spaces which are available at the plurality of parking dates and times. The parking management platform also submits a command service request through a command service at the parking management platform to a write database using the CQRS database access pattern to update a parking space allocation to reflect that the first parking space has been allocated at the plurality of parking dates and times selected from the plurality of configurable time intervals using the customer-selected recurrence measure. In selected embodiments, the parking management platform also receives, from the parking customer web application, payment for the first parking space after receiving the parking space reservation request. In selected embodiments, the parking management platform also stores, in a search cache memory, the parking space search request and the corresponding list of one or more parking spaces which are available at the plurality of parking dates and times. In selected embodiments, the parking management platform receives, from a management web application on a parking management backend server, an operator-configured plurality of configurable time intervals and price schedule information, and then communicates with the parking customer web application to display the operator-configured plurality of configurable time intervals and price schedule information with the list of one or more parking spaces which are available at the plurality of parking dates and times. In other embodiments, the parking management platform also starts a cart timer having a configurable time period in response to receiving the parking space reservation request. In other selected embodiments, the parking management platform transforms, with an enforcement service API gateway, a request received from an external enforcement provider into a format that a query service can submit to the read database, and also transforms, with the enforcement service API gateway, a response from the query service into a response format required by the external enforcement provider.

In yet another form, there is provided a parking management system, apparatus, method, and program code for dynamically managing parking spots in one or more parking facilities. The disclosed system includes a non-transitory memory storing one or more computer programs, and a processor executing the one or more programs. As a result, a customer computer device at the system displays a first parking search user interface screen which lists a customer-selectable start date field, a customer-selectable start-time field, a customer-selectable end-time field, a customer-selectable end date field, and a customer-selectable recurrence option. In addition, the system communicates, to an online parking management platform server, a parking space search request which specifies parking requirements comprising a customer-selected start date, a customer-selected start time selected from a first plurality of configurable time intervals, a customer-selected end time selected from a second plurality of configurable time intervals, a customer-selected end date, and a recurrence option which specifies a plurality of parking dates for the parking requirements. In addition, the system receives, from the online parking management platform server, a listing of one or more parking facilities with corresponding prices for parking spaces which match the parking requirements of the parking space search request. In addition, the customer computer device at the system displays, at the customer computer device, the listing of one or more parking facilities and corresponding prices. In addition, the system communicates, to the online parking management platform server, a parking space reservation request which specifies a customer-selected parking facility selected from the listing of one or more parking facilities.

Although the described exemplary embodiments disclosed herein focus on a parking management system which can allocate and track parking spaces using customer-specified granularity and recurrency options, the present disclosure is not necessarily limited to the example embodiments illustrate herein and may be applied to any reservation system. Thus, the particular embodiments disclosed above are illustrative only and should not be taken as limitations upon the present invention, as the invention may be modified and practiced in different but equivalent manners apparent to those skilled in the art having the benefit of the teachings herein. Accordingly, the foregoing description is not intended to limit the invention to the particular form set forth, but on the contrary, is intended to cover such alternatives, modifications and equivalents as may be included within the spirit and scope of the invention as defined by the appended claims so that those skilled in the art should understand that they can make various changes, substitutions and alterations without departing from the spirit and scope of the invention in its broadest form.

Benefits, other advantages, and solutions to problems have been described above with regard to specific embodiments. However, the benefits, advantages, solutions to problems, and any element(s) that may cause any benefit, advantage, or solution to occur or become more pronounced are not to be construed as a critical, required, or essential feature or element of any or all the claims. As used herein, the terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus.

1. A parking management system comprising:
a processor,
a memory coupled to the processor, and
a read database and a write database connected and configured to implement a command query responsibility segregation (CQRS) database access pattern,
where the memory stores computer executable instructions that when executed by the processor cause the processor to:
communicate with a parking customer web application to receive a parking space search request which specifies a plurality of parking dates and times selected from a plurality of configurable time intervals using a customer-selected recurrence measure which specifies that the times selected from the plurality of configurable time intervals may recur on selected days, weeks, or months between a customer-selected start date and end date;
submit a query service request to the read database using the CQRS database access pattern to retrieve a list of one or more parking spaces which are available at the plurality of parking dates and times;
communicate with the parking customer web application to display the list of one or more parking spaces which are available at the plurality of parking dates and times;
communicate with the parking customer web application to receive a parking space reservation request which selects a first parking space from the one or more parking spaces which are available at the plurality of parking dates and times; and
submit a command service request to the write database using the CQRS database access pattern to update a parking space allocation to reflect that the first parking space has been allocated at the plurality of parking dates and times selected from the plurality of configurable time intervals using the customer-selected recurrence measure.

2. The parking management system of claim 1, wherein the computer executable instructions stored in memory, when executed by the processor, cause the processor to communicate with the parking customer web application to receive payment information for the first parking space.

3. The parking management system of claim 1, further comprising a search cache memory for storing the parking space search request and the corresponding list of one or more parking spaces which are available at the plurality of parking dates and times.

4. The parking management system of claim 1, where the parking customer web application displays the list of one or more parking spaces with price schedule information for the customer.

5. The parking management system of claim 4, where the price schedule information includes different prices for different configurable time intervals.

6. The parking management system of claim 1, where the parking space search request specifies a parking facility selected from a plurality of parking facilities by a customer.

7. The parking management system of claim 1, further comprising a cart timer for setting a configurable time period for the customer to reserve and purchase the first parking space.

8. The parking management system of claim 1, where the customer-selected recurrence measure specifies that the times selected from the plurality of configurable time intervals may recur on customer-selected subset of up to four days in a week for a customer-selected time interval on each customer-selected subset of up to four days.

9. The parking management system of claim 1, wherein the computer executable instructions stored in memory, when executed by the processor, cause the processor to:
communicate with a management web application on a parking management backend server to receive operator-configured plurality of configurable time intervals and price schedule information; and
communicate with the parking customer web application to display the operator-configured plurality of configurable time intervals and price schedule information with the list of one or more parking spaces which are available at the plurality of parking dates and times.

10. The parking management system of claim 1, further comprising an enforcement service API gateway configured (1) to transform a request received from an external enforcement provider into a format that a query service can submit to the read database, and (2) to transform a response from the query service into a response format required by the external enforcement provider.

11. A computer-based method for managing a plurality of parking spaces at one or more parking facilities, comprising:
receiving, at a parking management platform, a parking space search request which specifies a plurality of parking dates and times selected by the customer from a plurality of configurable time intervals using a customer-selected recurrence measure, where the times selected from the plurality of configurable time intervals are less than a full day;
submitting a query service request through a query service at the parking management platform to a read database using a command query responsibility segregation (CQRS) database access pattern to retrieve a list of one or more parking spaces which are available at the plurality of parking dates and times;
communicating with a parking customer web application to display the list of one or more parking spaces which are available at the plurality of parking dates and times;
receiving from the parking customer web application a parking space reservation request which selects a first parking space from the one or more parking spaces which are available at the plurality of parking dates and times; and
submitting a command service request through a command service at the parking management platform to a write database using the CQRS database access pattern to update a parking space allocation to reflect that the first parking space has been allocated at the plurality of parking dates and times selected from the plurality of configurable time intervals using the customer-selected recurrence measure.

12. The computer-based method of claim 11, further comprising receiving, from the parking customer web application, payment for the first parking space after receiving the parking space reservation request.

13. The computer-based method of claim 11, further comprising storing, in a search cache memory, the parking space search request and the corresponding list of one or more parking spaces which are available at the plurality of parking dates and times.

14. The computer-based method of claim 11, where parking customer web application displays the list of one or more parking spaces with price schedule information assigned to different configurable time intervals selected by the customer.

15. The computer-based method of claim 11, where the customer-selected recurrence measure specifies that the times selected from the plurality of configurable time intervals may recur on selected days, weeks, or months between a customer-selected start date and end date.

16. The computer-based method of claim 11, where the customer-selected recurrence measure specifies that the times selected from the plurality of configurable time intervals may recur on customer-selected subset of up to four days in a week for a customer-selected time interval on each customer-selected subset of up to four days.

17. The computer-based method of claim 11, further comprising:
receiving, from a management web application on a parking management backend server, an operator-configured plurality of configurable time intervals and price schedule information; and
communicating with the parking customer web application to display the operator-configured plurality of configurable time intervals and price schedule information with the list of one or more parking spaces which are available at the plurality of parking dates and times.

18. The computer-based method of claim 11, further comprising starting a cart timer having a configurable time period in response to receiving the parking space reservation request.

19. The computer-based method of claim 11, further comprising:
transforming, by an enforcement service API gateway, a request received from an external enforcement provider into a format that a query service can submit to the read database; and
transforming, by the enforcement service API gateway, a response from the query service into a response format required by the external enforcement provider.

20. A parking management system, comprising:
a non-transitory memory storing one or more computer programs; and
a processor executing the one or more programs to:
display, at a customer computer device, a first parking search user interface screen which lists a customer-selectable start date field, a customer-selectable start-time field, a customer-selectable end-time field, a customer-selectable end date field, and a customer-selectable recurrence option;
communicate, to an online parking management platform server, a parking space search request which specifies parking requirements comprising a customer-selected start date, a customer-selected start time selected from a first plurality of configurable time intervals, a customer-selected end time selected from a second plurality of configurable time intervals, a customer-selected end date, and a recurrence option which specifies a plurality of parking dates for the parking requirements;
receive, from the online parking management platform server, a listing of one or more parking facilities with corresponding prices for parking spaces which match the parking requirements of the parking space search request;
display, at the customer computer device, the listing of one or more parking facilities and corresponding prices; and
communicate, to the online parking management platform server, a parking space reservation request which specifies a customer-selected parking facility selected from the listing of one or more parking facilities.
